(19) United States
(12) Patent Application Publication
(10) Pub. No.: US 2005/0274749 A1
(43) Pub. Date: Dec. 15, 2005

(54) Bendable dispensing device

(76) Inventor: John Wayne Labossiere, Harrisville, RI (US)

Correspondence Address: Raymond M. Galasso;Galasso & Associates LP, P.O. Box 26503, Austin, TX, 78755-0503, US

(21) Appl. No.: 11/136,901

(22) Filed: May 25, 2005

Related U.S. Application Data
(60) Provisional application No. 60/574,324, filed on May 25, 2004.

(51) Int. Cl. B67D 3/00

(52) U.S. Cl. 222/527

(57) ABSTRACT

A bendable dispensing device comprises a bendable tube, a dispensing tip and a mounting flange. The bendable tube includes a first end and a second end. The bendable tube includes a selectively positionable structure enabling the bendable tube to be fixedly positioned in a desired bent orientation. The dispensing tip is attached to the first end of the bendable tube. The mounting flange attached to the second end of the bendable tube.

### CROSS REFERENCE TO RELATED APPLICATIONS

This patent application claims priority to co-pending United States Provisional Patent Application having Ser. No. 60/574,324, filed May 25, 2004, entitled “Intentu”, having a common applicant herewith and being incorporated herein in its entirety by reference.

### FIELD OF THE DISCLOSURE

The disclosures made herein relate generally to dispensing apparatuses for flowable materials and, more particularly, to attachments for tubes of flowable material.

### BACKGROUND

Many types of materials dispensed with a caulk gun are known. Examples of these types of materials include, but are not limited to, caulk, roofing cement and adhesives. For simplicity, such materials are generally referred to herein as flowable materials in the context of a tube of flowable material.

Conventional tubes of flowable material include a material containing body having a dispensing tip (e.g., a tapered tube) attached to an end of the material-containing body. The dispensing tip is substantially rigid whereby it is not intended for or readily capable of being bent in the course of normal use of the tube of flowable material. In this manner, a conventional dispensing tip has a generally straight longitudinal axis that is substantially fixed with respect to a generally straight longitudinal axis of the material-containing body. The inability to bend the dispensing tip to a position where is it substantially skewed with respect to the generally straight longitudinal axis of the material-containing body is a drawback of such conventional tubes of flowable materials. In certain situations, this inability to bend the dispensing tip limits the ability to directly dispense material from the tube of flowable material to a desired area of deposit. For example, a caulk tube with a straight fixed-position dispensing tip is not capable of directly application of dispensed caulk in some tight spaces (e.g., tight corner, around the base of a toilet, around the edge of a bathtub or shower stall, etc). Additionally, conventional dispensing tips are relatively short and fixed-length, which also contributes to limitations in direct application of dispensed flowable material in that some desired areas of application are out of reach due to the overall size of the material-containing body limiting proximity to the desired area of application.

The typical solution to such drawbacks associated with conventional dispensing tips being non-bendable and relatively short is to apply flowable material to a secondary application article and apply the dispensed flowable material with the secondary application tool. Examples of such articles include, but are not limited to, a putty knife and a human finger. Application with such articles is undesirable as it is generally messy, wasteful and non-uniform.

Therefore, an apparatus that overcomes drawbacks associated with conventional dispensing tips of flowable material tubes would be useful and advantageous.

### SUMMARY OF THE DISCLOSURE

Embodiments of the present invention provide for an enhanced means for enabling a flowable material such as, for example, caulk to be dispensed from a dispensing apparatus. More specifically, embodiments of the present invention enable direct application of flowable materials from a material containing tube even in tight and/or awkward spaces. Such ability for direct application precludes the need for dispensing the flowable material and subsequently using a secondary application article to apply the flowable material, thereby improving uniformity of the applied material and reducing waste of dispensed material. Accordingly, the present invention advantageously overcomes one or more shortcomings associated with conventional dispensing apparatuses configured for dispensing materials such as caulk.

In one embodiment of the present invention, a bendable dispensing device comprises a bendable tube, a dispensing tip and a mounting flange. The bendable tube includes a first end and a second end. The bendable tube includes a selectively positionable structure enabling the bendable tube to be fixedly positioned in a desired bent orientation. The dispensing tip is attached to the first end of the bendable tube. The mounting flange attached to the second end of the bendable tube.

In another embodiment of the present invention, a bendable dispensing device comprises a bendable tube, a dispensing tip and a mounting flange. The bendable tube includes a first end and a second end and a plurality of accordion-like segments enabling a central axis of the first end to be skewed with respect to a central axis of the second end. The dispensing tip is attached to the first end of the bendable tube. The mounting flange is attached to the second end of the bendable tube.

In another embodiment of the present invention, a flowable material dispensing apparatus comprises a tubular body and a bendable dispensing device attached to the tubular body. The tubular body has a flowable material disposed therein. The bendable dispensing device includes a bendable tube, a dispensing tip and a mounting flange. The bendable tube has a first end and a second end. The dispensing tip is attached to the first end of the bendable tube. The mounting flange is attached to the second end of the bendable tube and to an end of the tubular body. The bendable tube includes a selectively positionable structure enabling the bendable tube to be fixedly positioned in a desired bent orientation.

Turning now to specific aspects of the present invention, in at least one embodiment, the selectively positionable structure includes a plurality of accordion-like segments.

In at least one embodiment of the present invention, the bendable tube includes a non-bendable segment extending between the selectively positionable structure and the mounting flange.

In at least one embodiment of the present invention, the selectively positionable structure includes a plurality of individually deformable segments enabling a central axis of a first one of the segments to be skewed with respect to a central axis of a second one of the deformable segments.

In at least one embodiment of the present invention, the mounting flange is circular-shaped.

In at least one embodiment of the present invention, the dispensing tip is tapered.

These and other objects, embodiments advantages and/or distinctions of the present invention will become readily apparent upon further review of the following specification, associated drawings and appended claims.

### BRIEF DESCRIPTION OF THE DRAWINGS

FIG. 1 depicts a bendable dispensing device in accordance with the present invention.

FIG. 2 is a cross-sectional view taken along line 2-2 in FIG. 1.

FIG. 3 depicts a flowable material dispensing apparatus in accordance with the present invention.

### DETAILED DESCRIPTION OF THE DRAWING FIGURES

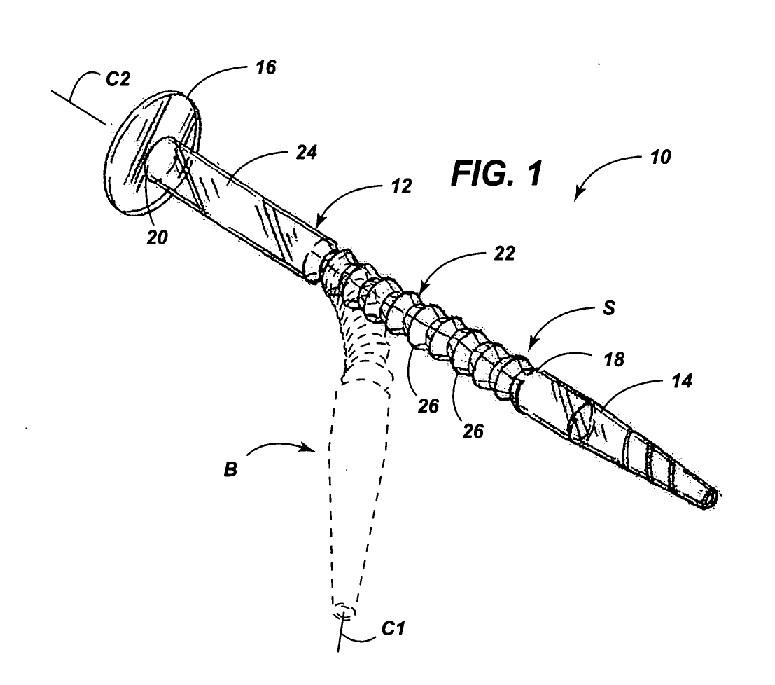

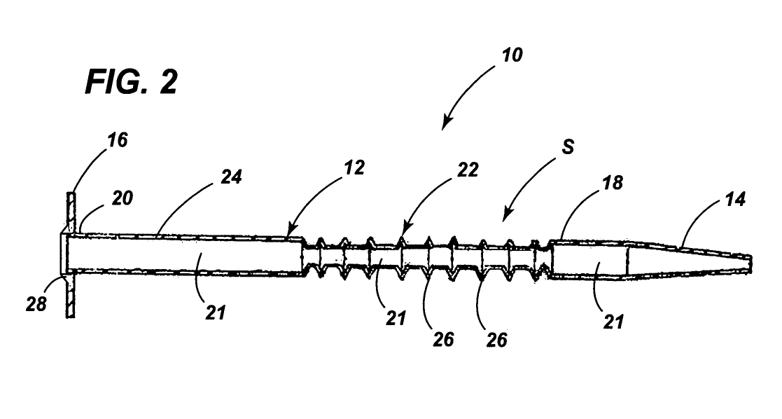

FIGS. 1 and 2 depict an embodiment of a bendable dispensing device in accordance with the present invention, is referred to herein as the bendable dispensing device 10. The bendable dispensing device 10 includes a bendable tube 12, a dispensing tip 14 and a mounting flange 16. The bendable tube 12 includes a first end 18 and a second end 20. The dispensing tip 14, which is preferably tapered, is attached to the first end 18 of the bendable tube 12. The mounting flange 16 attached to the second end 20 of the bendable tube 12. As is best depicted in FIG. 2, a passage 21 extends along an entire length of the bendable dispensing device 10.

The bendable tube 12 includes a selectively positionable structure 22 and a non-bendable segment 24. The non-bendable segment 24 extends between the selectively positionable structure 22 and the mounting flange 16. The selectively positionable structure 22 enables the bendable tube 12 to be moved from a generally straight orientation S to a bent orientation B and to be fixed in the bent orientation B. Accordingly, the selectively positionable structure 22 is constructed in a manner enabling it to be selectively bent but held in a desired position after being bent and while in use. In the bent configuration B, a central axis of the first end 18 of the bendable tube 12 is skewed with respect to a central axis of a second end 20 of the bendable tube 12. It is disclosed herein that the bent position B is one of many bent positions in which the bendable tube 12 may be moved to and fixed in.

In one embodiment, the selectively positionable structure 22 includes a plurality of individually deformable segments 26. The plurality of individually deformable segments 26 enable a central axis C1 of a first one of the segments 26 to be skewed with respect to a central axis C2 of a second one of the deformable segments 26. It is disclosed herein that the central axis of the first end 18 may be a central axis of a first one of the deformable segments 26 (e.g., a segment adjacent the first end 18) and that the central axis of the second end 20 may be a central axis of a second one of the deformable segments 26 (e.g., a segment adjacent the second end 20).

Deformation of the deformable segments 26 is an example of a means for enabling the bendable tube 12 to be moved from the generally straight orientation S to the bent orientation B and to be fixed in the bent orientation B. One example of the selectively positionable structure 22 is a structure including a plurality of accordion-like segments. In view of the disclosures made herein, a skilled person will appreciate other structures suitable for enabling such bending functionality.

As depicted, the mounting flange 16 is circular-shaped. However, it is disclosed herein that the mounting flange may be any number of other shapes. A sealing member 28 is attached to the mounting flange 16. One example of the sealing member 28 is a circular shaped ridge with a narrow and/or tapered cross sectional profile, whereby resiliency of the sealing member 28 is at least partially provided by the geometry of the sealing member (e.g., a tapered cross-sectional profile). Preferably, but not necessarily, the sealing member 28 is integral with the mounting flange 16.

In use, the bendable dispensing device 10 is slid over the dispensing tip of a conventional tube of flowable material (e.g., a conventional caulk tube). Once the bendable dispensing device 10 is in place, the conventional tube of flowable material and the bendable dispensing device 10 are placed into a conventional caulk gun in the conventional manner. Depressing a trigger of the caulk gun engages a displaceable member of the caulk gun with a plunger within a material-containing body of the tube of flowable material. In doing so, the tube of flowable material is pushed forward within the caulk gun until the mounting flange 16 of the bendable dispensing device 10 engages a forward support structure of the caulk gun. This engagement secures the mounting flange 16 in place relative to the tube of flowable material and results in the sealing member 28 coming into intimate contact with a mating portion of the tube of flowable material (i.e., an end face of the tube of flowable material). When finished, the bendable dispensing device 10 can remain in place or be removed and cleaned for next use.

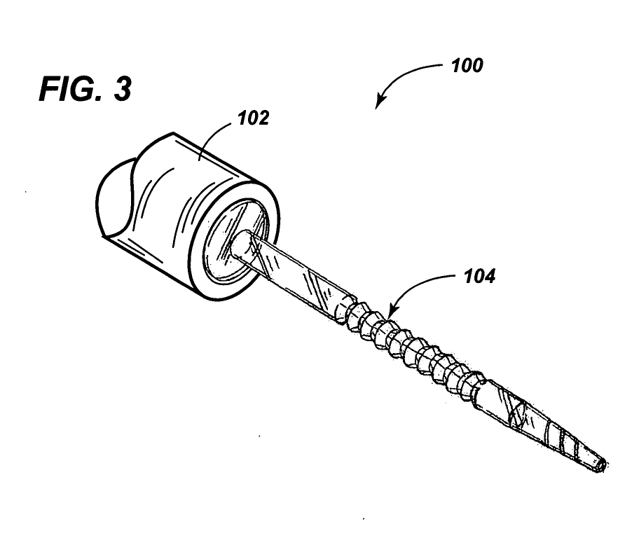

FIG. 3 depicts an embodiment of a flowable material dispensing apparatus in accordance with the present invention, which is referred to herein as the flowable material dispensing device 100. The flowable material dispensing apparatus 100 comprises a tubular body 102 having a flowable material disposed therein (i.e., a material-containing body) and a bendable dispensing device 104 fixedly attached to an end of the tubular body 102. The bendable dispensing device discussed above in reference to FIGS. 1 and 2 (i.e., the bendable dispensing device 10) is an example of the bendable dispensing device 104. Bending functionality of the bendable dispensing device 104 is substantially the same as that of the bendable dispensing device 10 discussed above in reference to FIGS. 1 and 2.

The flowable material dispensing apparatus 100 is used in a manner very similar to that of a conventional tube of flowable material. The key difference being that the bendable dispensing device may be bent to a desired bent orientation for enhancing dispensing and/or application of the flowable material contained in the tubular body 102.

Bendable dispensing devices in accordance with the present invention can be made according to any number of manufacturing techniques and from any number of specific materials. For example, a bendable dispensing device in accordance with the present invention may be made from a plastic material using a blow molding or rotational molding process. A skilled person will appreciate other suitable techniques for making bendable dispensing devices in accordance with the present invention.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A bendable dispensing device, comprising:
a bendable tube including a first end and a second end, wherein the bendable tube includes a selectively positionable structure enabling the bendable tube to be fixedly positioned in a desired bent orientation;
a dispensing tip attached to the first end of the bendable tube; and
a mounting flange attached to the second end of the bendable tube.

2. The bendable dispensing device of claim 1 wherein the selectively positionable structure includes a plurality of accordion-like segments.

3. The bendable dispensing device of claim 2 wherein the bendable tube includes a non-bendable segment extending between the selectively positionable structure and the mounting flange.

4. The bendable dispensing device of claim 1 wherein the selectively positionable structure includes a plurality of individually deformable segments enabling a central axis of a first one of said segments to be skewed with respect to a central axis of a second one of said deformable segments.

5. The bendable dispensing device of claim 1 wherein the mounting flange is circular-shaped.

6. The bendable dispensing device of claim 1 wherein the bendable tube includes a non-bendable segment extending between the selectively positionable structure and the mounting flange.

7. The bendable dispensing device of claim 1 wherein:
the selectively positionable structure includes a plurality of individually deformable segments enabling a central axis of a first one of said segments to be skewed with respect to a central axis of a second one of said deformable segments;
the mounting flange is circular-shaped; and
the bendable tube includes a non-bendable segment extending between the selectively positionable structure and the mounting flange.

8. A bendable dispensing device, comprising:
a bendable tube including a first end and a second end, wherein the bendable tube includes a plurality of accordion-like segments enabling a central axis of the first end to be skewed with respect to a central axis of the second end;
a dispensing tip attached to the first end of the bendable tube; and
a mounting flange attached to the second end of the bendable tube.

9. The bendable dispensing device of claim 8 wherein the mounting flange is circular-shaped.

10. The bendable dispensing device of claim 9 wherein the bendable tube includes a non-bendable segment extending between the selectively positionable structure and the mounting flange.

11. The bendable dispensing device of claim 10 wherein the dispensing tip is tapered.

12. A flowable material dispensing apparatus, comprising:
a tubular body having a flowable material disposed therein; and
a bendable dispensing device including a bendable tube, a dispensing tip and a mounting flange, wherein the bendable tube has a first end and a second end, wherein the dispensing tip is attached to the first end of the bendable tube, wherein the mounting flange is attached to the second end of the bendable tube and to an end of the tubular body and wherein the bendable tube includes a selectively positionable structure enabling the bendable tube to be fixedly positioned in a desired bent orientation.

13. The flowable material dispensing apparatus of claim 12 wherein the selectively positionable structure includes a plurality of accordion-like segments.

14. The flowable material dispensing apparatus of claim 13 wherein the bendable tube includes a non-bendable segment extending between the selectively positionable structure and the mounting flange.

15. The flowable material dispensing apparatus of claim 12 wherein the selectively positionable structure includes a plurality of individually deformable segments enabling a central axis of a first one of said segments to be skewed with respect to a central axis of a second one of said deformable segments.

16. The flowable material dispensing apparatus of claim 12 wherein the mounting flange is circular-shaped.

17. The flowable material dispensing apparatus of claim 12 wherein the bendable tube includes a non-bendable segment extending between the selectively positionable structure and the mounting flange.

18. The flowable material dispensing apparatus of claim 12 wherein:
the selectively positionable structure includes a plurality of individually deformable segments enabling a central axis of a first one of said segments to be skewed with respect to a central axis of a second one of said deformable segments;
the mounting flange is circular-shaped; and
the bendable tube includes a non-bendable segment extending between the selectively positionable structure and the mounting flange.
